(19) United States
(12) Patent Application Publication
(10) Pub. No.: US 2004/0128194 A1
(43) Pub. Date: Jul. 1, 2004

(54) Marketing system based on customer preferences

(76) Inventors: Stephen F. Mase, Minneapolis, MN (US); James P. Lynch, Minneapolis, MN (US); Joseph Hoppesch, Plymouth, MN (US); Gretchen M. Etzel, Minnetonka, MN (US); Nicholas J. Kozlak, Edina, MN (US); Jeffery J. Davis, New Brighton, MN (US)

Correspondence Address: Devan V. Padmanabhan, DORSEY & WHITNEY LLP, Intellectual Property Department, 50 South Sixth Street, Suite 1500, Minneapolis, MN, 55402-1498, US

(21) Appl. No.: 10/644,651

(22) Filed: Aug. 20, 2003

Related U.S. Application Data
(60) Provisional application No. 60/404,893, filed on Aug. 20, 2002.

(51) Int. Cl. G06F 17/60

(52) U.S. Cl. 705/14

(57) ABSTRACT

The present invention is a marketing system and method that matches customer requests and preferences with marketing offers and related information. The system scans electronic marketing offers made available by companies and presents these offers to customers, if a match is detected between the offer and the customer's preferences. Customer profiles are based on information entered by the customer as to what type of marketing offers they are interested in receiving. Each customer's information remains isolated from the product and service providers, which allows customers to protect their information from mass marketing.

### CROSS REFERENCE TO RELATED APPLICATION(S)

This application claim priority to provisional application No. 60/404,893, filed Aug. 20, 2003, which is hereby incorporated by reference in its entirety.

### FIELD OF THE INVENTION

The present invention is a marketing system and method that matches customer profiles to marketing offers.

### BACKGROUND OF THE INVENTION

Customers are beginning to “tune-out” marketing promotions as they become increasingly overloaded with unsolicited messages arriving through the mail, telephone, e-mail, Internet, and television and radio advertisements. Each of these communication channels typically relies on a mass-marketing approach to selling in which companies attempt to infer a customer's needs using a variety of analytical tools and techniques, and then present generic offers to prospective customers. This is a costly approach that usually has very low response rates. Customers have little control over the solicitations they receive and often become annoyed, even to the extent of terminating existing supplier relationships.

There is a need in the art for a marketing system where customers are in control of their supplier relationships such that only customers with a need and an interest in hearing about certain product and service offers receive the marketing solicitations. There is a further need for a marketing system where customers are the owners of their information and control when their information is shared with a product or service provider.

### BRIEF SUMMARY OF THE INVENTION

The present invention, according to one embodiment, is a marketing system that matches a customer profile to marketing offers. The marketing system includes a database including a customer profile containing information related to a customer's interests in products and services and a database including a plurality of marketing offers related to products and services. It further includes a server for executing a program operable to match a selected offer of the plurality of marketing offers to the customer profile.

The present invention, according to another embodiment, is a marketing method for matching a plurality of company offers with a plurality of customer profiles. The method includes evaluating the plurality of offers and the customer profiles and matching a selected offer to a selected customer profile.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is flow chart showing a method of matching marketing offers with customer interests, according to one embodiment of the present invention.

FIG. 2 is a schematic diagram showing a system of matching marketing offers with customer interests, according to one embodiment of the present invention.

### DETAILED DESCRIPTION

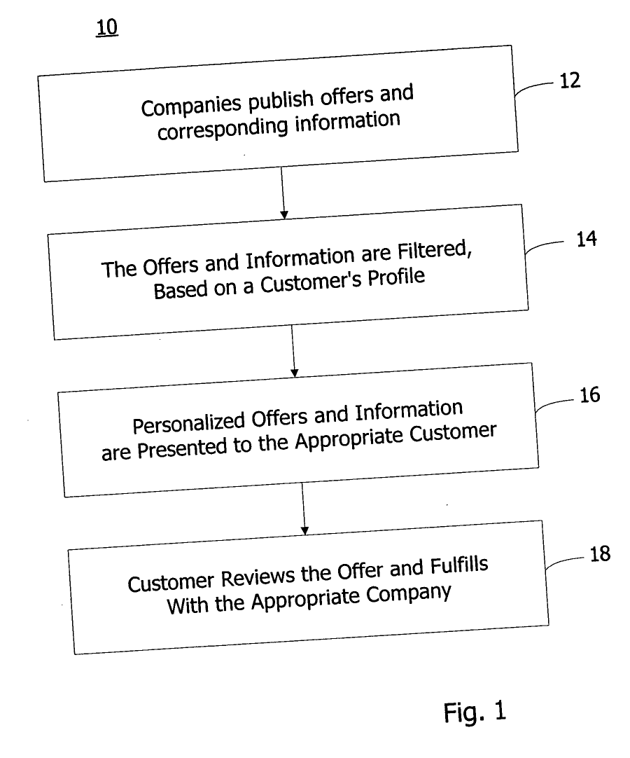

FIG. 1 is a flow chart showing a marketing method 10, according to one embodiment of the present invention. As shown in FIG. 1, the method 10 includes companies or entities publishing offers and related information (block 12), filtering the offers based on one or more customer profiles (block 14) and presenting personalized offers and the related information to the appropriate customers (block 16). The customer can then review the offer and information and accept or fulfill the offer with the offering company (block 18). The method 10 uses existing technologies (such as web services, dot net, XML and instant messaging), but combines them in new ways.

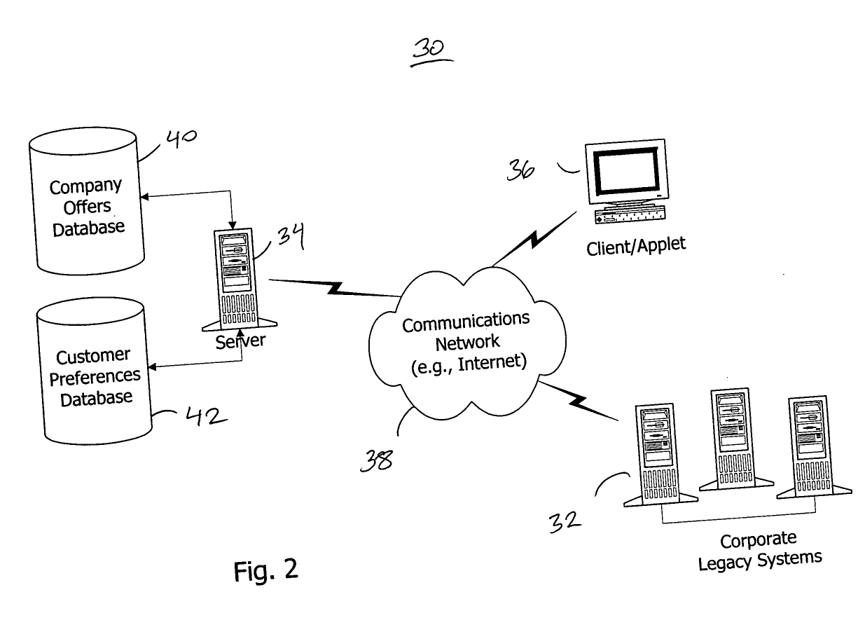

FIG. 2 is a diagram showing a marketing system 30, according to one embodiment of the present invention. As shown in FIG. 2, the system 30 includes corporate legacy systems 32, a server 34, and a client computer 36 in communication over a communications network 38. The server 34 includes or is coupled to one or more databases includes, for example, a company offers database 40 and a customer preferences or interests database 42. The server 34 includes a small, Internet-dispensed applet (an executable program) that can be instantly downloaded and installed on a customer's client computer 36. The applet is compliant with existing technology standards and is compatible with the vast majority of personal computers currently in the market. The applet may be persistently resident on the computer desktop, showing-up as a small icon in the computer's system tray or as a fully functional application that has a screen presence. The applet may be programmed and transmitted using any of a variety of techniques known to one or ordinary skill in the art.

The customer establishes his or her personal profile once within the applet, thus eliminating the need to reenter information. The customer establishes a permission-based marketing profile within the server to specify the types of offers that may be of interest. The desktop applet continuously communicates through the Internet to a variety of web services resident on remote servers or the corporate legacy systems 32, scanning for product and service offers that appear to match the customer's interest profile. In one embodiment, the product or service offers are made available to the server by one or more companies interested in marketing their products and services via a direct, electronic format. An application or servlet on the server 34 scans the product and service offers. If a match is found, it notifies the appropriate customer at the client 36 of the arrival of a new offer that matches is preferences. In one embodiment, the applet on the client 36 changes the appearance of the icon in the system tray, such as by changing the color or shape of the icon. In one embodiment, the applet communicates the customer preferences to the server for storage in a local database.

In one embodiment, a bubble message briefly appears above the icon inviting the customer to click on the icon to learn more about the offer. Upon clicking the icon, the offering is presented electronically to the customer in an attractive, graphical format. Because the offer is presented using a small applet, which has been downloaded to the customer's client computer 36, the offer can be presented in a much more robust manner than normally available through a traditional browser-based interface). The application on the server 34 leverages information provided by the customer to individually tailor each offer. It monitors the customer's response and applies an intelligent rules-driven, state-based campaign manager that changes the behavior of the applet based upon the customer's responses. A chat feature is integrated into the system to enable the customer to instantly communicate with the product or service provider should he/she have questions. In one embodiment, acceptance and fulfillment of the offer leverages information already provided by the customer.

In one embodiment, the system 30 is employed in the context of the market for a mortgage loan secured through an independent broker. The broker assists the customer in selecting a mortgage loan from a particular lender. The lender has the desire to develop a broader relationship with the customer beyond just the mortgage loan product. The lender invites the customer to keep updated on the status of their loan using a personalized Internet loan status dashboard. When the customer visits the dashboard, they are asked if they would be interested in hearing about additional products and services that are typically of interest to homebuyers and could help save the customer money at closing. After choosing to hear of these offers, the applet is downloaded to the customer's personal computer. The customer has granted the lender permission to leverage information to gather as part of the mortgage loan origination process to better tailor offers. The applet continuously evaluates the information being gathered in the loan origination process and presents product or service offers that would likely be of interest to the customer.

Although the present invention has been described with reference to preferred embodiments, persons skilled in the art will recognize that changes may be made in form and detail without departing from the spirit and scope of the invention.

We claim:

1. A marketing system that matches a customer profile to marketing offers, the marketing system comprising:
a database including a customer profile containing information related to a customer's interests in products and services;
a database including a plurality of marketing offers related to products and services; and
a server for executing a program operable to match a selected offer of the plurality of marketing offers to the customer profile.

2. The system of claim 1 further wherein the program is operable to present marketing offers to each customer, based on the results of the matching agent.

3. The system of claim 1 wherein the marketing offers are located on a plurality of distributed databases, the database in communication through a communications network.

4. The system of claim 3 wherein the plurality of databases are located on-site at a company originating at least one of the marketing offers.

5. The system of claim 1 wherein the databases are directly coupled to the server.

6. The system of claim 1 further including a client computer in communication with the server via a communications network.

7. The system of claim 6 wherein the client computer includes an applet received from the server.

8. The system of claim 7 wherein the applet is configured to prompt the customer using the client computer to enter the customer profile.

9. The system of claim 8 wherein the applet is further configured to communicate the customer profile to the server.

10. The system of claim 7 wherein the applet is configured to notify the customer at the client computer upon occurrence of a match to the selected offer.

11. A marketing method for matching a plurality of company offers with a plurality of customer profiles, the method comprising evaluating the plurality of offers and the customer profiles and matching a selected offer to a selected customer profile.

12. The method of claim 11 further including communicating the selected offer to the customer.

13. The method of claim 1 wherein the selected offer is communicated to a client computer via a computer network.

14. The method of claim 12 further including fulfilling the selected offer with its corresponding company wherein the step of fulfilling uses at least a portion of the customer profile.

15. The method of claim 1 wherein the customer profile includes an identification of the customer and a preference of the customer.

16. A marketing method for matching a plurality of company offers with a plurality of customer profiles, the method comprising:
receiving the plurality of company offers, the offers including corresponding offer information;
receiving the plurality of customer profiles, the profiles including a customer identification and a customer preference; and
matching at least one of the plurality of company offers to a selected customer profiles, based on the customer preference.

17. The method of claim 16 further comprising communicating the at least one offer to a customer corresponding to the selected customer profile.

18. The method of claim 17 further comprising fulfilling the at least one offer, wherein the step of fulfilling uses at least a portion of the customer profile.

19. The method of claim 16 wherein the customer profile includes a mailing address.

20. A computer data signal embodied in a transmission medium, comprising a first code segment for soliciting a customer profile, the profile including a customer identification and a customer preference, and a second code segment for receiving a marketing offer from a company.
